(19) United States
(12) Patent Application Publication
(10) Pub. No.: US 2026/0129436 A1
(43) Pub. Date: May 7, 2026

(54) NETWORK-BASED AUTHENTICATION IN AN AMBIENT INTERNET OF THINGS ARCHITECTURE

(71) Applicant: QUALCOMM Incorporated, San Diego, CA (US)

(72) Inventors: Hongil KIM, San Diego, CA (US); Soo Bum LEE, San Diego, CA (US); Sebastian SPEICHER, Wallisellen (CH)

(21) Appl. No.: 19/376,787

(22) Filed: Oct. 31, 2025

Related U.S. Application Data
(60) Provisional application No. 63/716,075, filed on Nov. 4, 2024.

(51) Int. Cl. H04W 12/041; H04W 12/0431; H04W 12/069

(52) U.S. Cl. CPC H04W 12/041; H04W 12/0431; H04W 12/069

(57) ABSTRACT

Various aspects of the present disclosure generally relate to wireless communication. In some aspects, an ambient Internet of Things (AIoT) device may perform an authentication and key agreement procedure with a network function to generate a root key. The AIoT device may receive, from an AIoT controller, a key confirmation message. The AIoT device may generate, using the key confirmation message and the root key, a protection key. The AIoT device may transmit, to the AIoT controller, a key confirmation acknowledgement using the protection key and in response to the key confirmation message. Numerous other aspects are described.

### CROSS-REFERENCE TO RELATED APPLICATION

This Patent Application claims priority to U.S. Provisional Patent Application No. 63/716,075, filed on November 4, 2024, entitled “NETWORK-BASED AUTHENTICATION IN AN AMBIENT INTERNET OF THINGS ARCHITECTURE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with network-based authentication in an ambient Internet of Things architecture.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by an ambient Internet of Things (AIoT) device. The method may include performing an authentication and key agreement (AKA) procedure with a network function to generate a root key. The method may include receiving, from an AIoT controller, a key confirmation message. The method may include generating, using the key confirmation message and the root key, a protection key. The method may include transmitting, to the AIoT controller, a key confirmation acknowledgement using the protection key and in response to the key confirmation message.

Some aspects described herein relate to a method of wireless communication performed by an AIoT controller. The method may include forwarding messages between an AIoT device and a network function to facilitate an AKA procedure. The method may include receiving, from the network function, a root key associated with the AIoT controller. The method may include transmitting, to the AIoT device, a key confirmation message. The method may include validating, from the AIoT device, a key confirmation acknowledgement using a protection key derived from the root key.

Some aspects described herein relate to a method of wireless communication performed by a network function. The method may include receiving an authentication trigger request associated with an AIoT device. The method may include performing an AKA procedure with the AIoT device to generate a master key. The method may include generating, using the master key with an ID for an AIoT controller, a service ID, or a combination thereof, a root key associated with the AIoT controller. The method may include transmitting, to the AIoT controller, the root key.

Some aspects described herein relate to an AIoT device. The AIoT device may include a processing system that includes one or more processors and one or more code-storing memories coupled with the one or more processors. The processing system may be configured to cause the AIoT device to perform an AKA procedure with a network function to generate a root key. The processing system may be configured to cause the AIoT device to receive, from an AIoT controller, a key confirmation message. The processing system may be configured to cause the AIoT device to generate, using the key confirmation message and the root key, a protection key. The processing system may be configured to cause the AIoT device to transmit, to the AIoT controller, a key confirmation acknowledgement using the protection key and in response to the key confirmation message.

Some aspects described herein relate to an AIoT controller. The AIoT controller may include a processing system that includes one or more processors and one or more code-storing memories coupled with the one or more processors. The processing system may be configured to cause the AIoT controller to forward messages between an AIoT device and a network function to facilitate an AKA procedure. The processing system may be configured to cause the AIoT controller to receive, from the network function, a root key associated with the AIoT controller. The processing system may be configured to cause the AIoT controller to transmit, to the AIoT device, a key confirmation message. The processing system may be configured to cause the AIoT controller to validate, from the AIoT device, a key confirmation acknowledgement using a protection key derived from the root key.

Some aspects described herein relate to a network function. The network function may include a processing system that includes one or more processors and one or more code-storing memories coupled with the one or more processors. The processing system may be configured to cause the network function to receive an authentication trigger request associated with an AIoT device. The processing system may be configured to cause the network function to perform an AKA procedure with the AIoT device to generate a master key. The processing system may be configured to cause the network function to generate, using the master key with an ID for an AIoT controller, a service ID, or a combination thereof, a root key associated with the AIoT controller. The processing system may be configured to cause the network function to transmit, to the AIoT controller, the root key.

Some aspects described herein relate to a non-transitory computer-readable medium that stores a set of instructions for wireless communication by an AIoT device. The set of instructions, when executed by one or more processors of the AIoT device, may cause the AIoT device to perform an AKA procedure with a network function to generate a root key. The set of instructions, when executed by one or more processors of the AIoT device, may cause the AIoT device to receive, from an AIoT controller, a key confirmation message. The set of instructions, when executed by one or more processors of the AIoT device, may cause the AIoT device to generate, using the key confirmation message and the root key, a protection key. The set of instructions, when executed by one or more processors of the AIoT device, may cause the AIoT device to transmit, to the AIoT controller, a key confirmation acknowledgement using the protection key and in response to the key confirmation message.

Some aspects described herein relate to a non-transitory computer-readable medium that stores a set of instructions for wireless communication by an AIoT controller. The set of instructions, when executed by one or more processors of the AIoT controller, may cause the AIoT controller to forward messages between an AIoT device and a network function to facilitate an AKA procedure. The set of instructions, when executed by one or more processors of the AIoT controller, may cause the AIoT controller to receive, from the network function, a root key associated with the AIoT controller. The set of instructions, when executed by one or more processors of the AIoT controller, may cause the AIoT controller to transmit, to the AIoT device, a key confirmation message. The set of instructions, when executed by one or more processors of the AIoT controller, may cause the AIoT controller to validate, from the AIoT device, a key confirmation acknowledgement using a protection key derived from the root key.

Some aspects described herein relate to a non-transitory computer-readable medium that stores a set of instructions for wireless communication by a network function. The set of instructions, when executed by one or more processors of the network function, may cause the network function to receive an authentication trigger request associated with an AIoT device. The set of instructions, when executed by one or more processors of the network function, may cause the network function to perform an AKA procedure with the AIoT device to generate a master key. The set of instructions, when executed by one or more processors of the network function, may cause the network function to generate, using the master key with an ID for an AIoT controller, a service ID, or a combination thereof, a root key associated with the AIoT controller. The set of instructions, when executed by one or more processors of the network function, may cause the network function to transmit, to the AIoT controller, the root key.

Some aspects described herein relate to an apparatus for wireless communication. The apparatus may include means for performing an AKA procedure with a network function to generate a root key. The apparatus may include means for receiving, from an AIoT controller, a key confirmation message. The apparatus may include means for generating, using the key confirmation message and the root key, a protection key. The apparatus may include means for transmitting, to the AIoT controller, a key confirmation acknowledgement using the protection key and in response to the key confirmation message.

Some aspects described herein relate to an apparatus for wireless communication. The apparatus may include means for forwarding messages between an AIoT device and a network function to facilitate an AKA procedure. The apparatus may include means for receiving, from the network function, a root key associated with the AIoT controller. The apparatus may include means for transmitting, to the AIoT device, a key confirmation message. The apparatus may include means for validating, from the AIoT device, a key confirmation acknowledgement using a protection key derived from the root key.

Some aspects described herein relate to an apparatus for wireless communication. The apparatus may include means for receiving an authentication trigger request associated with an AIoT device. The apparatus may include means for performing an AKA procedure with the AIoT device to generate a master key. The apparatus may include means for generating, using the master key with an ID for an AIoT controller, a service ID, or a combination thereof, a root key associated with the AIoT controller. The apparatus may include means for transmitting, to the AIoT controller, the root key.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example of an ambient Internet of Things (AIoT) architecture, in accordance with the present disclosure.

FIGS. 3A-3B are diagrams illustrating an example associated with network-based authentication in an AIoT architecture, in accordance with the present disclosure.

FIGS. 4A-4B are diagrams illustrating an example associated with network-based authentication in an AIoT architecture, in accordance with the present disclosure.

FIGS. 5, 6, and 7 are diagrams illustrating example processes associated with network-based authentication in an AIoT architecture, in accordance with the present disclosure.

FIGS. 8, 9, and 10 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In an ambient Internet of Things (AIoT) architecture, an AIoT device may be used for inventory, sensor measurements, or package tracking, among other examples. An AIoT device may include a passive Internet of Things (IoT) device, a semi-passive IoT device, an active IoT device, or ultra-light IoT device. The AIoT device may communicate with an AIoT reader (e.g., at a checkpoint or periodically). An AIoT reader may be a user equipment (UE), a network node, or another type of device that wireless communicates with the AIoT device. The AIoT reader may communicate with an AIoT controller to report detected AIoT devices with enrichment data (e.g., Global Navigation Satellite System (GNSS) location and/or a neighbor cell identifier (ID), among other examples) and relay commands. An AIoT controller may be a network node or another type of device that connects the AIoT reader to a network (e.g., a 5G network). Accordingly, the AIoT controller may communicate with an application function (e.g., deployed by a service provider for the AIoT service) and a core network (e.g., providing network connectivity and deployed by a network operator).

Communications to and from the AIoT device (e.g., via the AIoT reader) may be secured using a credential provisioned for the AIoT controller by the application function. However, using the application function results in the credentials being unusable by the core network. Accordingly, communications between the core network and the AIoT device without the application function (e.g., control information from the core network and measurements from the AIoT device, among other examples) may be unsecure.

Various aspects relate generally to using an authentication and key agreement (AKA) procedure to authenticate an AIoT device and generate a protection key (e.g., at least one protection key). AKA may refer to an extensible authentication protocol (EAP) AKA procedure (e.g., an EAP-AKAʹ procedure) that may, for example, be used as a mutual authentication process between a device (e.g., an A-IoT device) and a host (e.g., an A-IoT reader or a network function), such as the EAP-AKAʹ procedure standardized by the Third Generation Partnership Project (3GPP) (e.g., in technical specification (TS) 33.501) the 5G AKA procedure standardized by the 3GPP (e.g., in TS 33.501). In other examples, AKA can refer to other authentication technologies that may be standardized or described in another version of 3GPP specifications, another standard, or another non-3GPP specification. Some aspects more specifically relate to deriving the protection key from a root key that was generated using the AKA procedure. The root key may be a key associated with the AIoT device and may serve as a basis for deriving additional keys for encryption and integrity protection, and the protection key can be a key used to secure messages (e.g., between the AIoT controller and the AIoT device). More generally, a “key” described herein may refer to a cryptographic key, which is a piece of information (e.g., a string of letters or numbers) that work with a cryptographic algorithm for authentication, encoding, or decoding of data. In some aspects, the protection key can be used to enable encryption or integrity verification. For example, the protection key may be used with an encryption algorithm or an integrity check to secure messages using encryption or integrity verification, respectively. In some aspects, the AIoT controller and the AIoT device may perform a key confirmation procedure such that the AIoT device may generate the root key (and thus the protection key). The key confirmation procedure may include a key confirmation message from the AIoT controller to the AIoT device, which may request that the AIoT device confirm derivation of the protection key by decrypting or verifying the key confirmation message, and a key confirmation acknowledgement from the AIoT device to the AIoT controller, which may serve as evidence that the AIoT devices has derived the protection key.

Particular aspects of the subject matter described in this disclosure can be implemented to realize one or more of the following potential advantages. In some examples, the described techniques can be used to secure communications between the core network and the AIoT device without the application function. Additionally, the described techniques can be used to generate the root key from a master key generated by the core network, which further improves security. The master key may serve as a basis for the root key, which in turn serves as a basis for the protection key, resulting in a key hierarchy (e.g., a tree structure).

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the 3GPP. 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases. Herein, a “network function” may refer to a portion of a core network that is implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

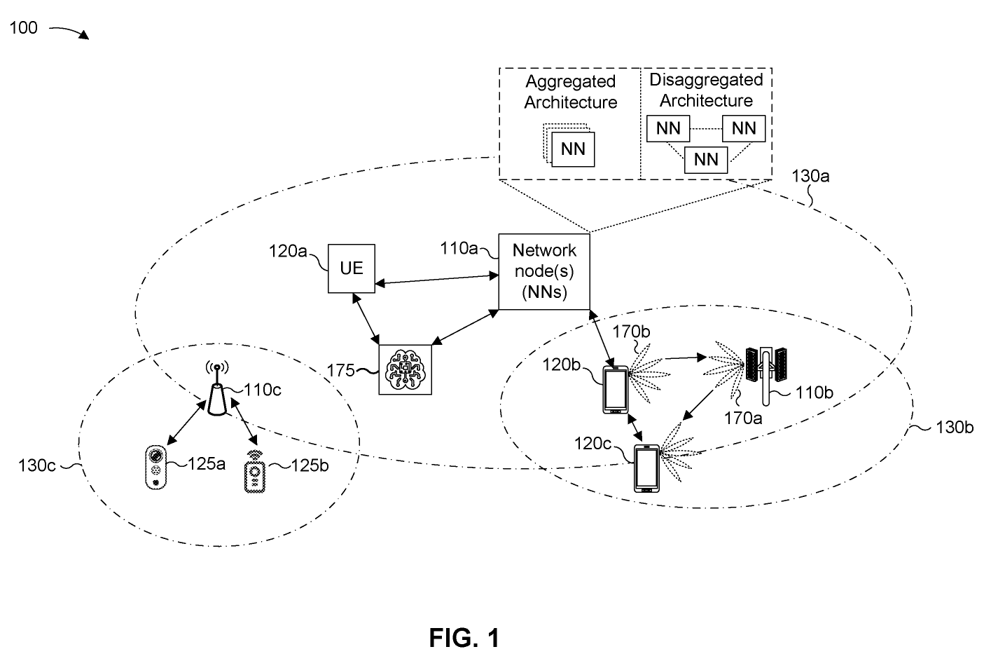

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a a network node 110b, and a network node 110c. The network nodes 110 may support communications with multiple UEs 120. For example, in FIG. 1, the network nodes 110 support communication with a UE 120a, a UE 120b, and a UE 120c. As further shown in FIG. 1, the network node 110c supports communication with multiple IoT devices 125 (e.g., AIoT device 125a and AIoT device 125b). In some examples, a UE 120 may also communicate with other UEs 120 and a network node 110 may communicate with a core network and with other network nodes 110.

Some IoT devices, such as AIoT devices (sometimes referred to as ultra-light IoT devices), may be associated with a relatively simple hardware design that may be designed to use low power and be implementable at low cost. AIoT technology may include passive IoT (such as NR passive IoT for 5G Advanced), semi-passive IoT, active IoT, or ultra-light IoT. In passive IoT, a terminal (such as a tag or a similar device) may not include a battery or other long-term energy storage, and the terminal may accumulate energy from radio signaling. In some examples, the terminal may accumulate solar or other energy to supplement accumulated energy from radio signaling. To achieve further cost reduction and zero-power communication, backscattering communication may be implemented at a type of passive IoT device referred to as an “ambient backscatter device” or a “backscatter device,” which may modulate a reflecting radio signal from an RF source to convey data. Some IoT devices may be referred to as semi-passive IoT devices. At a semi-passive IoT device, communication between a reader and the IoT device does not need to be preceded by an energy harvesting waveform. For example, a semi-passive IoT device may include a battery or similar energy source that can power the semi-passive IoT device. Some IoT devices may be referred to as active IoT devices. An active IoT device may have a battery or similar energy source and an active radio, allowing for active transmission and reception without energy harvesting or backscattering. AIoT technology may be useful in connection with industrial sensors, for which battery replacement may be prohibitively difficult or undesirable (such as for safety monitoring or fault detection in smart factories, infrastructures, or environments). Additionally, features of AIoT devices, such as low cost, small size, simple or infrequent maintenance, durability, and long lifespan, may facilitate smart logistics and warehousing (for example, in connection with automated asset management). Furthermore, AIoT technology may be useful in connection with smart home networks for household item management, wearable devices, or similar applications.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

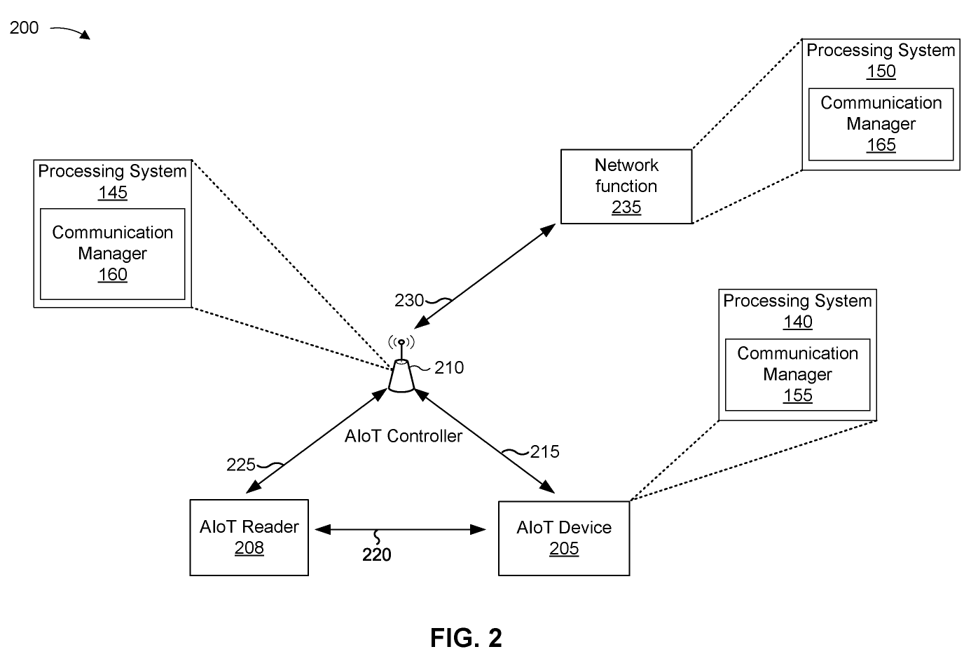

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a GNSS device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 170a, and the UE 120b may generate one or more beams 170b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 170a of the network node 110) and the UE 120 receiving and measuring the signal(s) via respective beams of multiple beams (for example, from the beams 170b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 175 (for example, a network node 110 and/or UEs 120). For example, the one or more devices 175 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

FIG. 2 is a diagram illustrating an example 200 of an AIoT architecture, in accordance with the present disclosure. Some wireless communication devices may be considered IoT devices, such as AIoT devices (sometimes referred to as ultra-light IoT devices), or similar IoT devices.

AIoT devices may be categorized into at least three types of devices: device 1, device 2a, and device 2b. Device 1 type AIoT devices may include at least some passive and/or semi-passive devices. A device 1 type AIoT device may have approximately 1 microWatt (µW) peak power consumption, support energy storage, use an initial sampling frequency offset (SFO) up to 10X parts per million (ppm) (for example, where X can be any suitable value), and communicate uplink transmissions by backscattering externally-provided continuous waves (CWs).

Device 2a type AIoT devices may include at least some semi-passive devices, and device 2b type AIoT devices may include active devices. Both device 2a and device 2b type AoT devices may have less than or equal to a few hundred µW peak power consumption, support energy storage, and use an initial SFO up to 10X ppm. A device 2a type AIoT device may communicate uplink transmissions by backscattering externally-provided CWs. A device 2b type AIoT device may communicate uplink transmissions by internally generating the uplink transmission.

In some examples, device 1, device 2a, and/or device 2b type AIoT devices that are located indoors may support a maximum distance of 10-50 meters, a range which may be sub-selected. In Topology 1 (for example, in which an AIoT device may directly and bidirectionally communicate with one or more network nodes 110) and in Topology 2 (for example, in which an AIoT device may communicate bidirectionally with an intermediate node between the AIoT device and a network node 110), device 1, device 2a, and/or device 2b type AIoT devices may not support RRC states, mobility (for example, cell-selection/re-selection-like functionality), automatic repeat request (ARQ), or hybrid ARQ (HARQ).

In AIoT, a terminal (for example, an radio frequency identification (RFID) device, a tag, or a similar device) may not include a battery, and the terminal may accumulate energy from radio signaling. To achieve further cost reduction and zero-power communication, wireless networks may utilize a type of AIoT device referred to as an “ambient backscatter device” or a “backscatter device.”

As shown in FIG. 2, an AIoT device 205 (for example, a tag or a sensor, among other examples), which may be one example of an AIoT device, such as a passive, semi-passive, or active ambient IoT device described above, may employ a simplified hardware design (for example, including a power splitter, an energy harvester, and a microcontroller) that does not include a battery, such that the AIoT device 205 relies on energy harvesting for power, and that does not include a radio wave generation circuit, such that the AIoT device 205 is capable of transmitting information only by reflecting a radio wave. More particularly, the AIoT device 205 communicates with an AIoT reader 208 (for example, a UE 120, a network node 110, or another network device) by modulating a reflecting radio signal from an AIoT controller 210 (for example, a network node 110, a UE 120, or another network device). In some examples, the AIoT controller 210 and the AIoT reader 208 may be the same device and/or may be co-located. For example, in some instances, the AIoT reader 208 and the AIoT controller 210 may be associated with the same network node 110. The AIoT controller 210 may communicate with the AIoT device 205 over a broadcast link 215. The AIoT device 205 may communicate with the AIoT reader 208 over a link 220, and the AIoT reader 208 and the AIoT controller 210 may communicate over a link 225. Additionally, the AIoT controller 210 may communicate with a core network (e.g., including at least one network function 235) over a link 230 (e.g., a wired and/or wireless backhaul link). The core network may provide data to the AIoT controller 210 for transmission to the AIoT device 205 (e.g., on a user plane) and may provide control information for transmission to the AIoT device 205 (e.g., on a control plane).

In some aspects, the AIoT device 205 may include a processing system 140 with a communication manager 155. As described in more detail elsewhere herein, the communication manager 155 may perform an AKA procedure with the network function 235 to generate a root key; may receive, from the AIoT controller 210, a key confirmation message; may generate, using the key confirmation message and the root key, a protection key; and may transmit, to the AIoT controller, a key confirmation acknowledgement using the protection key and in response to the key confirmation message. Additionally, or alternatively, the communication manager 155 may perform one or more other operations described herein.

In some aspects, the AIoT controller 210 may include a processing system 145 with a communication manager 160. As described in more detail elsewhere herein, the communication manager 160 may forward messages between the AIoT device 205 and the network function 235 to facilitate an AKA procedure; may receive, from the network function 235, a root key associated with the AIoT controller 210; may transmit, to the AIoT device 205, a key confirmation message; and may validate, from the AIoT device 205, a key confirmation acknowledgement using a protection key derived from the root key. Additionally, or alternatively, the communication manager 160 may perform one or more other operations described herein.

In some aspects, the network function 235 may include a processing system 150 with a communication manager 165. As described in more detail elsewhere herein, the communication manager 165 may receive an authentication trigger request associated with the AIoT device 205; may perform an AKA procedure with the AIoT device 205 to generate a master key; may generate, using the master key with an ID for the AIoT controller 210, a service ID, or a combination thereof, a root key associated with the AIoT controller 210; and may transmit, to the AIoT controller 210, the root key. Additionally, or alternatively, the communication manager 165 may perform one or more other operations described herein.

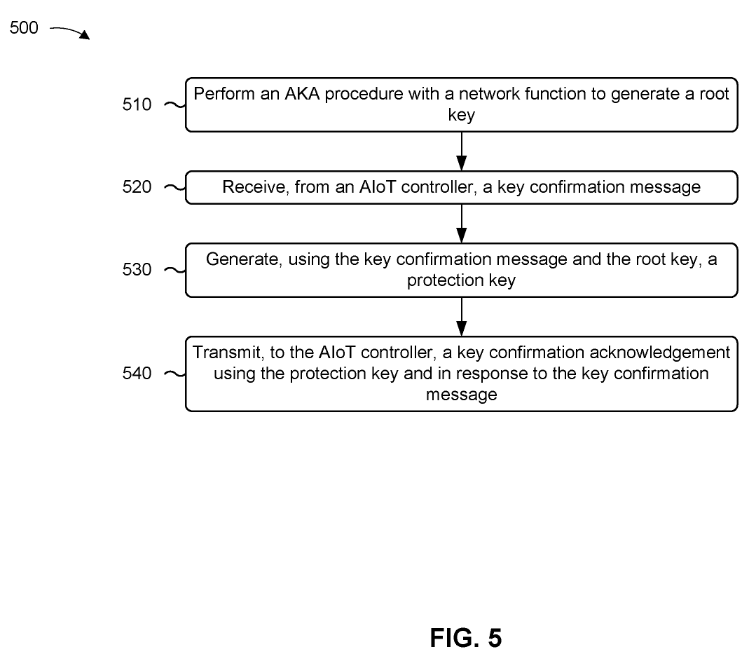

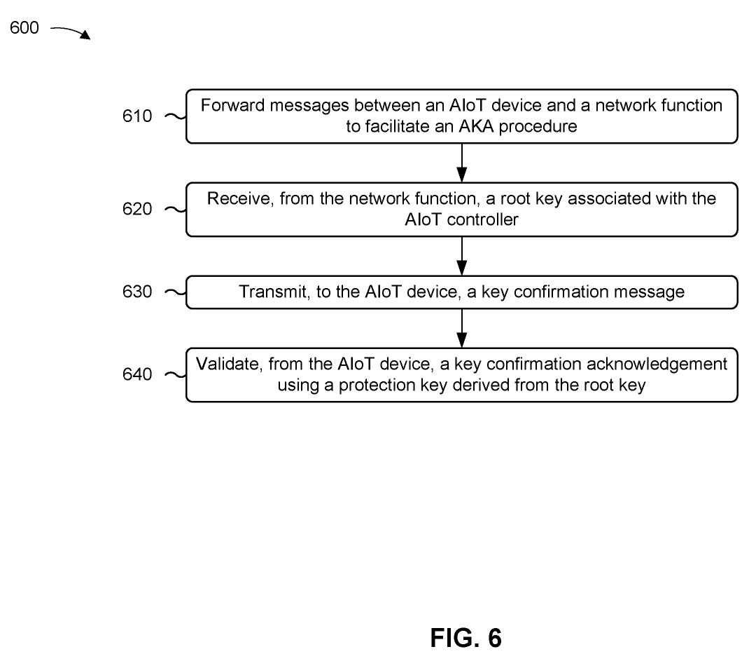

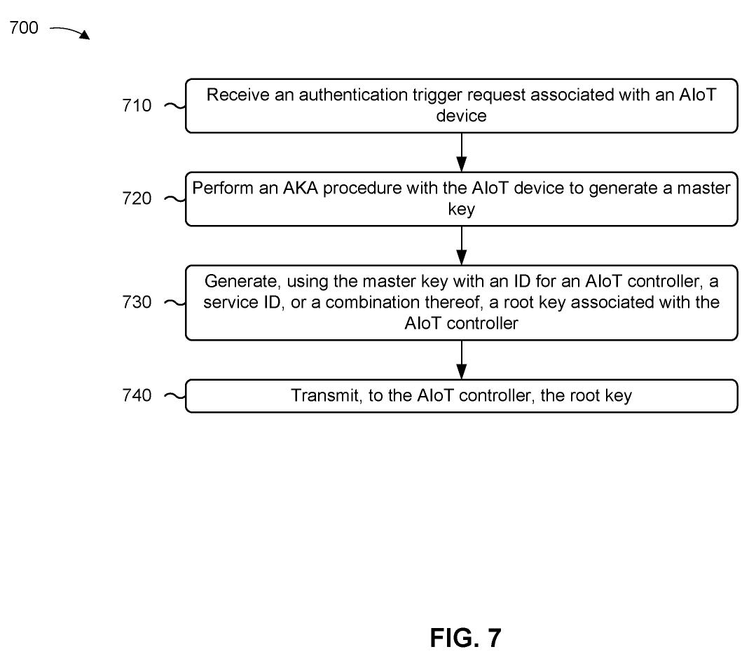

The AIoT controller 210, the processing system 145 of the AIoT controller, the AIoT device 205, the processing system 140 of the AIoT device 205, the AIoT reader 208, the network function 235, the processing system 150 of the network function 235, or any other component(s) of FIG. 1 and/or FIG. 2 may implement one or more techniques or perform one or more operations associated with network-based authentication in an AIoT architecture, as described in more detail elsewhere herein. For example, the processing system 145 of the AIoT controller, the processing system 140 of the AIoT device 205, the processing system 150 of the network function 235, or the AIoT reader 208 may perform or direct operations of, for example, process 500 of FIG. 5, process 600 of FIG. 6, process 700 of FIG. 7, or other processes as described herein (alone or in conjunction with one or more other processors). Memory of the AIoT controller 210 may store data and program code (or instructions) for the AIoT controller 210. In some examples, the memory of the AIoT controller 210 may store data relating to an AIoT device 205, such as device information. Memory of the AIoT device 205 may store data and program code (or instructions) for the AIoT device 205, such as context information. Memory of the network function 235 may store data and program code (or instructions) for the network function 235, such as network information. In some examples, the memory of the AIoT device 205, the memory of the AIoT controller 210, or the memory of the network function 235 may include a non-transitory computer-readable medium storing a set of instructions for wireless communication. For example, the set of instructions, when executed by one or more processors (for example, of the processing system 150, processing system 145, or the processing system 140) of the AIoT device 205, the AIoT controller 210, or the network function 235 may cause the one or more processors to perform process 500 of FIG. 5, process 600 of FIG. 6, process 700 of FIG. 7, or other processes as described herein. In some examples, executing instructions may include running the instructions, converting the instructions, compiling the instructions, and/or interpreting the instructions, among other examples.

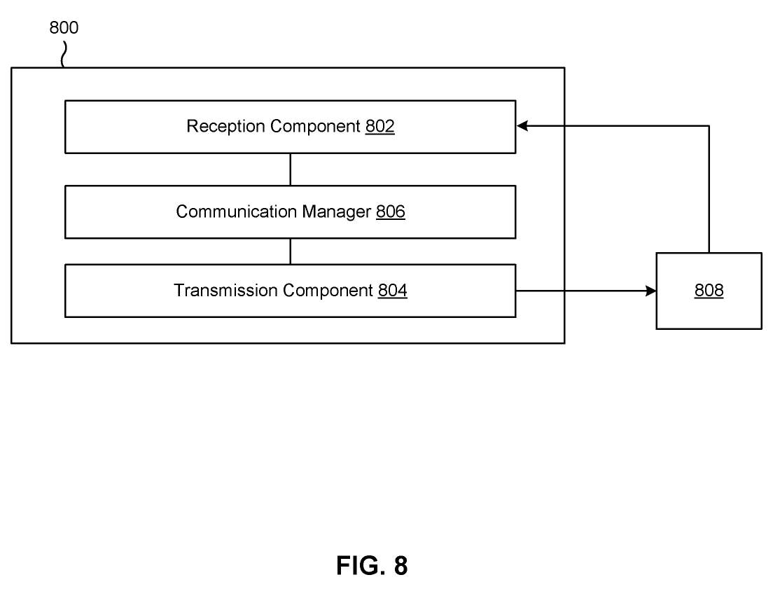

In some aspects, an AIoT device (e.g., AIoT device 205 and/or apparatus 800 of FIG. 8) may include means for performing an AKA procedure with a network function to generate a root key; means for receiving, from an AIoT controller, a key confirmation message; means for generating, using the key confirmation message and the root key, a protection key; and/or means for transmitting, to the AIoT controller, a key confirmation acknowledgement using the protection key and in response to the key confirmation message. In some aspects, the means for the AIoT device to perform operations described herein may include, for example, one or more of communication manager 155, processing system 140, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

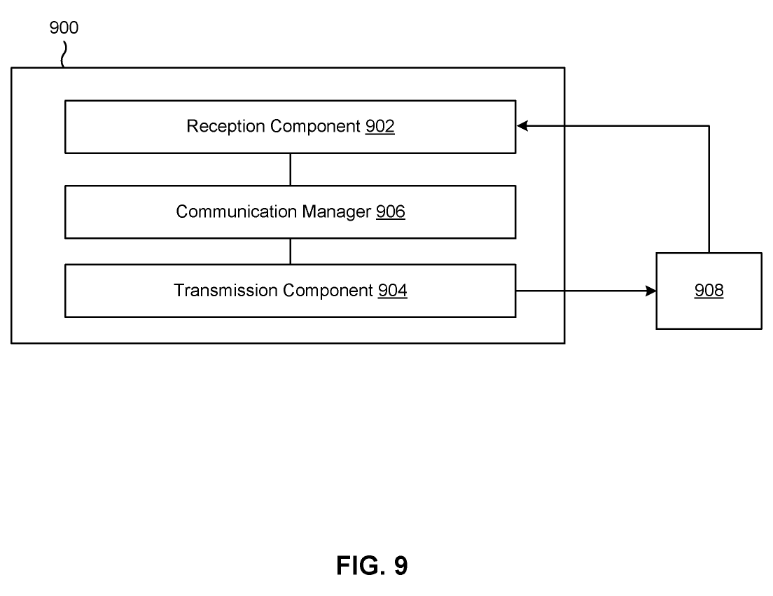

In some aspects, an AIoT controller (e.g., AIoT controller 210 and/or apparatus 900 of FIG. 9) may include means for forwarding messages between an AIoT device and a network function to facilitate an AKA procedure; means for receiving, from the network function, a root key associated with the AIoT controller; means for transmitting, to the AIoT device, a key confirmation message; and/or means for validating, from the AIoT device, a key confirmation acknowledgement using a protection key derived from the root key. In some aspects, the means for the AIoT controller to perform operations described herein may include, for example, one or more of communication manager 160, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

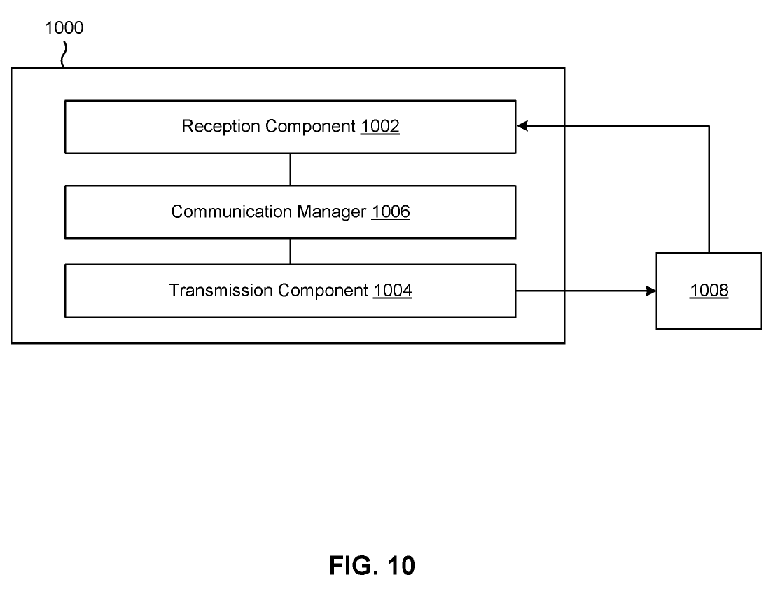

In some aspects, a network function (e.g., network function 235 and/or apparatus 1000 of FIG. 10) may include means for receiving an authentication trigger request associated with an AIoT device; means for performing an AKA procedure with the AIoT device to generate a master key; means for generating, using the master key with an ID for an AIoT controller, a service ID, or a combination thereof, a root key associated with the AIoT controller; and/or means for transmitting, to the AIoT controller, the root key. In some aspects, the means for the network function to perform operations described herein may include, for example, one or more of communication manager 165, processing system 150, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

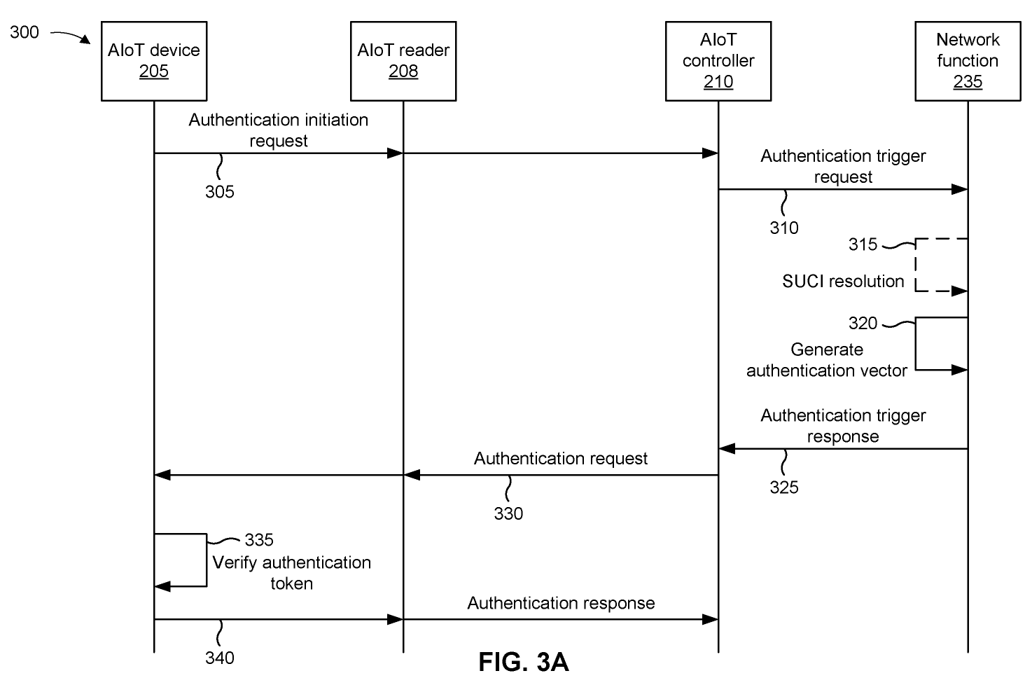

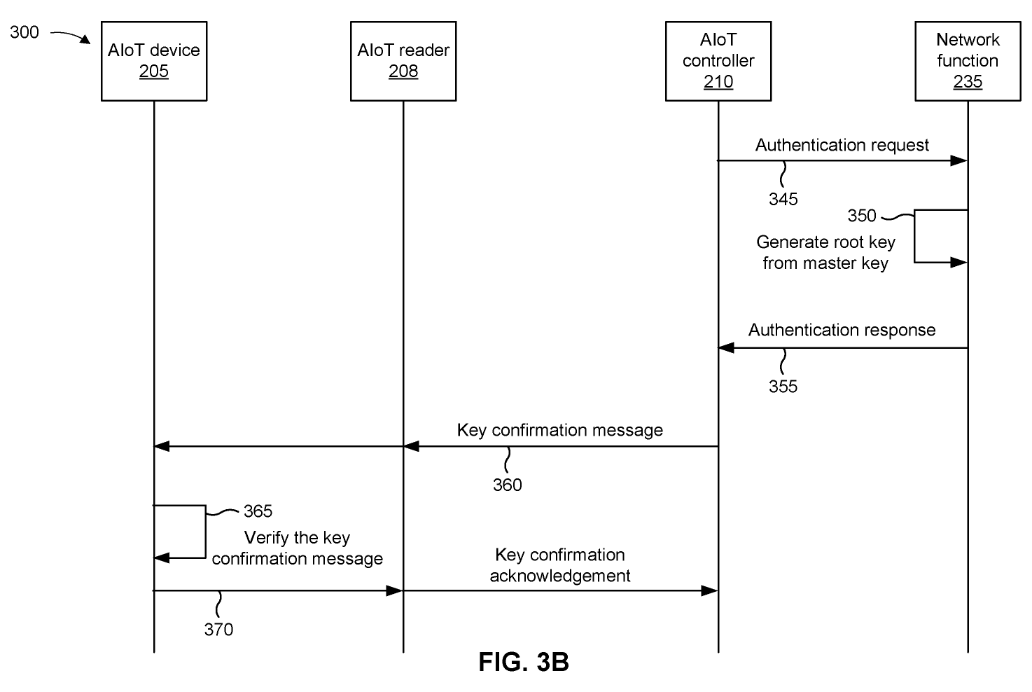

FIGS. 3A-3B are diagrams illustrating an example 300 associated with network-based authentication in an AIoT architecture, in accordance with the present disclosure. As shown in FIGS. 3A-3B, a network function 235 (e.g., an authentication server function (AUSF)), an AIoT controller 210, an AIoT reader 208, and an AIoT device 205 may communicate with one another.

As shown in FIG. 3A and by reference number 305, the AIoT device 205 may transmit (e.g., via the AIoT reader 208), and the AIoT controller 210 may receive (e.g., via the AIoT reader 208) an authentication initiation request. The AIoT device 205 may transmit the authentication initiation request in response to detecting that the AIoT device 205 lacks security keys. The authentication initiation request may include an indication of the AIoT device 205 (e.g., using a subscription concealed identifier (SUCI) associated with the AIoT device 205, among other examples). For example, a universal integrated circuit card (UICC) of the AIoT device 205 may calculate the SUCI for the AIoT device 205. The authentication initiation request may further include a service ID (e.g., based on a service being requested by the AIoT device 205) and/or an ID associated with the AIoT controller 210.

As shown by reference number 310, the AIoT controller 210 may transmit, and the network function 235 may receive, an authentication trigger request. The AIoT controller 210 may transmit the authentication trigger request in response to the authentication initiation request from the AIoT device 205. Alternatively, the AIoT controller 210 may initiate authentication without an authentication initiation request from the AIoT device 205. For example, the AIoT controller 210 may transmit the authentication trigger request in response to detecting that the AIoT controller 210 lacks security keys or detecting expiry of a credential at the AIoT controller 210. Alternatively, an application function (not shown) may transmit, and the AIoT controller 210 may receive, a service request. For example, the service request may indicate the AIoT device 205 (e.g., using a device ID) and may trigger the AIoT controller 210 to initiate authentication of the AIoT device 205 (e.g., by transmitting the authentication trigger request to the network function 235).

The authentication trigger request may include an indication of the AIoT device 205 to be authenticated (e.g., using the SUCI associated with the AIoT device 205, among other examples). The authentication trigger request may further include a service ID (e.g., from an application function, as described above) and/or an ID associated with the AIoT controller 210.

In some aspects, and as shown by reference number 315, the network function 235 may resolve one identifier for the AIoT device 205 (e.g., the SUCI described above) into a different identifier for the AIoT device 205 (e.g., a subscriber permanent identifier (SUPI), among other examples). In one example, the network function 235 may request, and receive, the different identifier from a unified data management (UDM) function. Alternatively, the AIoT controller 210 may resolve the SUCI into the SUPI (and include the SUPI in the authentication trigger request rather than the SUCI).

As shown by reference number 320, the network function 235 may generate an authentication vector. For example, the network function 235 may request, and receive, the vector from a UDM function. The vector may include a random number (also referred to as “RAN” or “RAND”), an authentication token (AUTN), an expected response (XRES), a transformed cipher key (CKʹ), and a transformed integrity key (IKʹ), among other examples.

As shown by reference number 325, the network function 235 may transmit, and the AIoT controller 210 may receive, an authentication trigger response. The authentication trigger response may include RAND and AUTN, as described above.

As shown by reference number 330, the AIoT controller 210 may transmit (e.g., via the AIoT reader 208), and the AIoT device 205 may receive (e.g., via the AIoT reader 208), an authentication request. The authentication request may include RAND and AUTN, as described above. Accordingly, as shown by reference number 335, the AIoT device 205 may verify the AUTN in the authentication request. Additionally, the AIoT device 205 may generate a response (RES) along with CKʹ and IKʹ, as described above.

As shown by reference number 340, the AIoT device 205 may transmit (e.g., via the AIoT reader 208), and the AIoT controller 210 may receive (e.g., via the AIoT reader 208), an authentication response. The authentication response may include RES, as described above.

As shown in FIG. 3B and by reference number 345, the AIoT controller 210 may transmit, and the network function 235 may receive, the authentication response. For example, the AIoT controller 210 may forward the authentication response from the AIoT device 205 to the network function 235.

As shown by reference number 350, the network function 235 may generate a root key (e.g., K AIoT_controller) from a master key (e.g., K AUSF) that is generated as a result of an AKA procedure (e.g., as described in connection with FIG. 3A). For example, the network function 235 may verify the authentication response by determining that XRES and RES, as described above, match. The network function 235 may derive an extended master session key (EMSK) from CKʹ and IKʹ, as described above. In some aspects, most significant bits (MSBs) of the EMSK (e.g., the 256 most significant bits, in one example) function as the master key K AUSF. The network function 235 may therefore derive the root key K AIoT_controller from the master key K AUSF along with the ID associated with the AIoT controller 210 and/or a service ID (e.g., as described above).

As shown by reference number 355, the network function 235 may transmit, and the AIoT controller 210 may receive, an authentication response. The authentication response may include the root key, as described above. Additionally, the AIoT controller 210 may generate a protection key (e.g., K_AIoT_ENC and/or K_AIoT_INC) from the root key. One or more algorithms for generating the protection key may be preconfigured for the AIoT controller 210 (e.g., programmed into a memory of the AIoT controller 210, optionally according to 3GPP specifications or another standard). Alternatively, the AIoT controller 210 may choose a selected algorithm and indicate the selected algorithm to the AIoT device 205 (e.g., as described below).

As shown by reference number 360, the AIoT controller 210 may transmit (e.g., via the AIoT reader 208), and the AIoT device 205 may receive (e.g., via the AIoT reader 208), a key confirmation message. In some aspects, the key confirmation message may indicate the selected algorithm. Accordingly, as shown by reference number 365, the AIoT device 205 may verify the key confirmation message (e.g., using the root key generated from the AKA procedure). For example, the key confirmation message may be integrity protected based on the protection key. Accordingly, the AIoT device 205 may derive the protection key from the root key (using the selected algorithm or by inferring the selected algorithm during verification of the key confirmation message).

As shown by reference number 370, the AIoT device 205 may transmit (e.g., via the AIoT reader 208), and the AIoT controller 210 may receive (e.g., via the AIoT reader 208), a key confirmation acknowledgement. The key confirmation acknowledgement may be encoded and/or protected using the protection key. In one example, the key confirmation acknowledgement is confidentiality and integrity protected based on the protection key. Accordingly, the AIoT controller 210 may verify that the AIoT device 205 has correctly derived the protection key. The AIoT controller 210 may use the protection key to encode and/or protect messages to the AIoT device 205, and similarly the AIoT device 205 may use the protection key to encode and/or protect messages to the AIoT controller 210.

In one example, the key confirmation procedure between the AIoT device 205 and the AIoT controller 210 may be performed using non-access stratum (NAS) signaling between the AIoT device 205 and AIoT controller 210. In another example, the key confirmation procedure between the AIoT device 205 and the AIoT controller 210 may be piggybacked over NAS signaling between the AIoT reader 208 and the network function 235. In another example, the key confirmation procedure between the AIoT device 205 and the AIoT controller 210 may be performed using a new user plane protocol.

By using techniques as described in connection with FIGS. 3A-3B, messages between the AIoT controller 210 and the AIoT device 205 are protected using the protection key, which improves security. In some examples, messages may be encrypted, such that the messages are protected from interception. In some examples, the messages may be verified, such that the AIoT controller 210 and the AIoT device 205 may detect and reject phony communications.

As indicated above, FIGS. 3A-3B are provided as an example. Other examples may differ from what is described with respect to FIGS. 3A-3B.

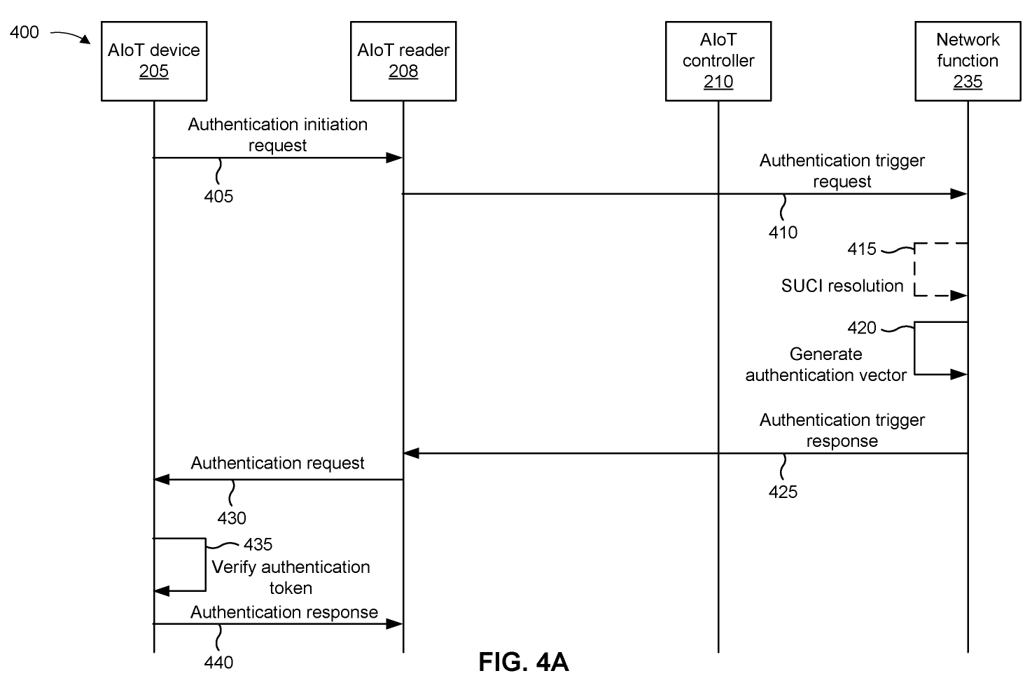

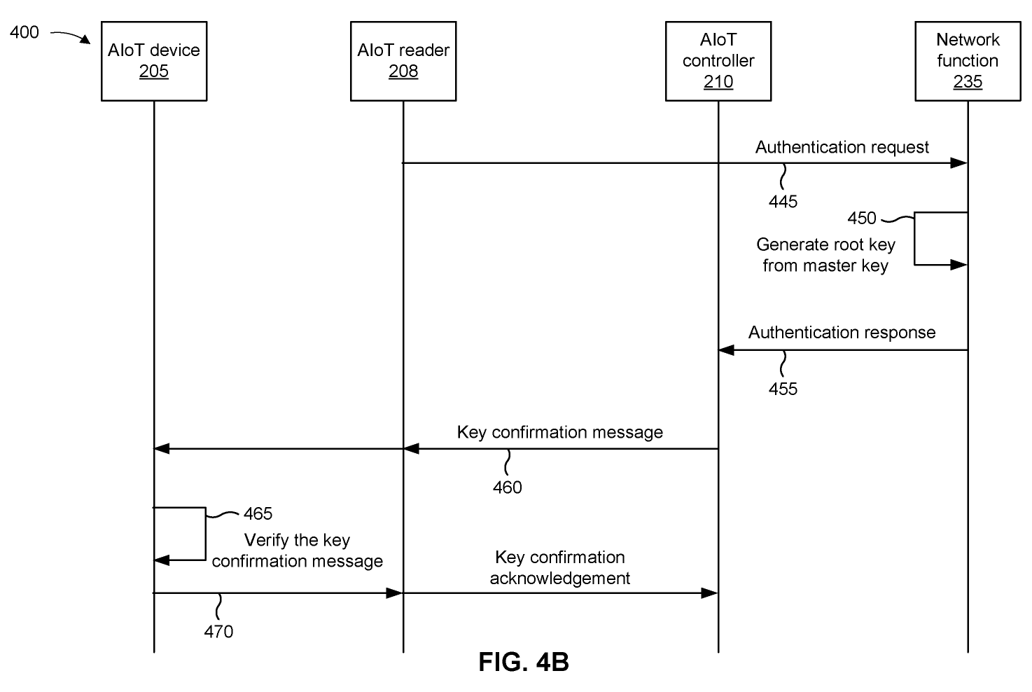

FIGS. 4A-4B are diagrams illustrating an example 400 associated with network-based authentication in an AIoT architecture, in accordance with the present disclosure. As shown in FIGS. 4A-4B, a network function 235 (e.g., an access and mobility management function (AMF)), an AIoT controller 210, an AIoT reader 208, and an AIoT device 205 may communicate with one another.

As shown in FIG. 4A and by reference number 405, the AIoT device 205 may transmit, and the AIoT reader 208 may receive, an authentication initiation request. The AIoT device 205 may transmit the authentication initiation request in response to detecting that the AIoT device 205 lacks security keys. The authentication initiation request may include an indication of the AIoT device 205 (e.g., using a SUCI associated with the AIoT device 205, among other examples). For example, a UICC of the AIoT device 205 may calculate the SUCI for the AIoT device 205. The authentication initiation request may further include a service ID (e.g., based on a service being requested by the AIoT device 205) and/or an ID associated with the AIoT controller 210.

As shown by reference number 410, the AIoT reader 208 may transmit, and the network function 235 may receive, an authentication trigger request. The AIoT reader 208 may transmit the authentication trigger request in response to the authentication initiation request from the AIoT device 205. In one example, the AIoT reader 208 and the network function 235 may communicate using an NG application protocol (NGAP). In another example, the AIoT reader 208 and the network function 235 may communicate using NAS signaling.

Alternatively, the AIoT controller 210 may initiate authentication instead. For example, the AIoT controller 210 may transmit the authentication trigger request in response to detecting that the AIoT controller 210 lacks security keys or detecting expiry of a credential at the AIoT controller 210. Alternatively, an application function (not shown) may transmit, and the AIoT controller 210 may receive, a service request. For example, the service request may indicate the AIoT device 205 (e.g., using a device ID) and may trigger the AIoT controller 210 to initiate authentication of the AIoT device 205 (e.g., by transmitting the authentication trigger request to the network function 235).

The authentication trigger request may include an indication of the AIoT device 205 to be authenticated (e.g., using the SUCI associated with the AIoT device 205, among other examples). The authentication trigger request may further include a service ID (e.g., from an application function, as described above) and/or an ID associated with the AIoT controller 210.

In some aspects, as shown by reference number 415, the network function 235 may resolve one identifier for the AIoT device 205 (e.g., the SUCI described above) into a different identifier for the AIoT device 205 (e.g., a SUPI, among other examples). In one example, the network function 235 may request, and receive, the different identifier from a UDM function. Alternatively, the AIoT reader 208 may resolve the SUCI into the SUPI (and include the SUPI in the authentication trigger request rather than the SUCI).

As shown by reference number 420, the network function 235 may generate an authentication vector. For example, the network function 235 may request, and receive, the vector from a UDM function. The vector may include a random number (also referred to as “RAN” or “RAND”), an AUTN, and a derived expected response (XRES*), among other examples.

As shown by reference number 425, the network function 235 may transmit, and the AIoT reader 208 may receive, an authentication trigger response. The authentication trigger response may include RAND and AUTN, as described above.

As shown by reference number 430, the AIoT reader 208 may transmit, and the AIoT device 205 may receive, an authentication request. The authentication request may include RAND and AUTN, as described above. Accordingly, as shown by reference number 435, the AIoT device 205 may verify the AUTN in the authentication request. Additionally, the AIoT device 205 may generate a derived response (RES*).

As shown by reference number 440, the AIoT device 205 may transmit, and the AIoT reader 208 may receive, an authentication response. The authentication response may include RES*, as described above.

As shown in FIG. 4B and by reference number 445, the AIoT reader 208 may transmit, and the network function 235 may receive, the authentication response. For example, the AIoT reader 208 may forward the authentication response from the AIoT device 205 to the network function 235.

As shown by reference number 450, the network function 235 may generate a root key (e.g., K AIoT_controller) from a master key (e.g., K AMF) that is generated as a result of an AKA procedure (e.g., as described in connection with FIG. 4A). For example, the network function 235 may verify the authentication response by determining that XRES* and RES*, as described above, match. The network function 235 may therefore derive the root key K AIoT_controller from the master key K AMF along with the ID associated with the AIoT controller 210 and/or a service ID (e.g., as described above).

As shown by reference number 455, the network function 235 may transmit, and the AIoT controller 210 may receive, an authentication response. The authentication response may include the root key, as described above. Additionally, the AIoT controller 210 may generate a protection key (e.g., K_AIoT_ENC and/or K_AIoT_INC) from the root key. One or more algorithms for generating the protection key may be preconfigured for the AIoT controller 210 (e.g., programmed into a memory of the AIoT controller 210, optionally according to 3GPP specifications or another standard). Alternatively, the AIoT controller 210 may choose a selected algorithm and indicate the selected algorithm to the AIoT device 205 (e.g., as described below).

As shown by reference number 460, the AIoT controller 210 may transmit (e.g., via the AIoT reader 208), and the AIoT device 205 may receive (e.g., via the AIoT reader 208), a key confirmation message. In some aspects, the key confirmation message may indicate the selected algorithm. Accordingly, as shown by reference number 465, the AIoT device 205 may verify the key confirmation message (e.g., using the root key generated from the AKA procedure). For example, the key confirmation message may be integrity protected based on the protection key. Accordingly, the AIoT device 205 may derive the protection key from the root key (using the selected algorithm or by inferring the selected algorithm during verification of the key confirmation message).

As shown by reference number 470, the AIoT device 205 may transmit (e.g., via the AIoT reader 208), and the AIoT controller 210 may receive (e.g., via the AIoT reader 208), a key confirmation message. The key confirmation message may be encoded and/or protected using the protection key. Accordingly, the AIoT controller 210 may verify that the AIoT device 205 has correctly derived the protection key. The AIoT controller 210 may use the protection key to encode and/or protect messages to the AIoT device 205, and similarly the AIoT device 205 may use the protection key to encode and/or protect messages to the AIoT controller 210.

In one example, the key confirmation procedure between the AIoT device 205 and the AIoT controller 210 may be performed using NAS signaling between the AIoT device 205 and AIoT controller 210. In another example, the key confirmation procedure between the AIoT device 205 and the AIoT controller 210 may be piggybacked over NAS signaling between the AIoT reader 208 and the network function 235. In another example, the key confirmation procedure between the AIoT device 205 and the AIoT controller 210 may be performed using a new user plane protocol.

By using techniques as described in connection with FIGS. 4A-4B, messages between the AIoT controller 210 and the AIoT device 205 are protected using the protection key, which improves security. In some examples, messages may be encrypted, such that the messages are protected from interception. In some examples, the messages may be verified, such that the AIoT controller 210 and the AIoT device 205 may detect and reject phony communications.

As indicated above, FIGS. 4A-4B are provided as an example. Other examples may differ from what is described with respect to FIGS. 4A-4B.

FIG. 5 is a diagram illustrating an example process 500 performed, for example, at an AIoT device or an apparatus of an AIoT device, in accordance with the present disclosure. Example process 500 is an example where the apparatus or the AIoT device (e.g., AIoT device 205) performs operations associated with network-based authentication in an AIoT architecture.

As shown in FIG. 5, in some aspects, process 500 may include performing an AKA procedure with a network function to generate a root key (block 510). For example, the AIoT device (e.g., using reception component 802, transmission component 804, and/or communication manager 806, depicted in FIG. 8) may perform an AKA procedure with a network function to generate a root key, as described herein.

As further shown in FIG. 5, in some aspects, process 500 may include receiving, from an AIoT controller, a key confirmation message (block 520). For example, the AIoT device (e.g., using reception component 802 and/or communication manager 806) may receive, from an AIoT controller, a key confirmation message, as described herein.

As further shown in FIG. 5, in some aspects, process 500 may include generating, using the key confirmation message and the root key, a protection key (block 530). For example, the AIoT device (e.g., using communication manager 806) may generate, using the key confirmation message and the root key, a protection key, as described herein.

As further shown in FIG. 5, in some aspects, process 500 may include transmitting, to the AIoT controller, a key confirmation acknowledgement using the protection key and in response to the key confirmation message (block 540). For example, the AIoT device (e.g., using transmission component 804 and/or communication manager 806) may transmit, to the AIoT controller, a key confirmation acknowledgement using the protection key and in response to the key confirmation message, as described herein.

Process 500 may include additional aspects, such as any single aspect or any combination of aspects described below and/or in connection with one or more other processes described elsewhere herein.

In a first aspect, the AKA procedure includes an EAP-AKAʹ procedure, and the network function includes an AUSF.

In a second aspect, alone or in combination with the first aspect, the root key is generated based on a master key that is generated as a result of the AKA procedure and using an ID for the AIoT controller, a service ID, or combination thereof.

In a third aspect, alone or in combination with one or more of the first and second aspects, the AKA procedure includes a 5G AKA procedure, and the network function includes an AMF.

In a fourth aspect, alone or in combination with one or more of the first through third aspects, process 500 includes transmitting (e.g., using transmission component 804 and/or communication manager 806), to the AIoT controller, an authentication request.

In a fifth aspect, alone or in combination with one or more of the first through fourth aspects, the authentication request is transmitted in response to detecting that the AIoT device lacks security keys.

In a sixth aspect, alone or in combination with one or more of the first through fifth aspects, the key confirmation message indicates a selected algorithm.

In a seventh aspect, alone or in combination with one or more of the first through sixth aspects, the key confirmation message is integrity protected based on the protection key that is generated using the root key and the selected algorithm.

In an eighth aspect, alone or in combination with one or more of the first through seventh aspects, the key confirmation acknowledgement is confidentiality and integrity protected based on the protection key.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at an AIoT controller or an apparatus of an AIoT controller, in accordance with the present disclosure. Example process 600 is an example where the apparatus or the AIoT controller (e.g., AIoT controller 210) performs operations associated with network-based authentication in an AIoT architecture.

As shown in FIG. 6, in some aspects, process 600 may include forwarding messages between an AIoT device and a network function to facilitate an AKA procedure (block 610). For example, the AIoT controller (e.g., using reception component 902, transmission component 904, and/or communication manager 906, depicted in FIG. 9) may forward messages between an AIoT device and a network function to facilitate an AKA procedure, as described herein.

As further shown in FIG. 6, in some aspects, process 600 may include receiving, from the network function, a root key associated with the AIoT controller (block 620). For example, the AIoT controller (e.g., using reception component 902 and/or communication manager 906) may receive, from the network function, a root key associated with the AIoT controller, as described herein.

As further shown in FIG. 6, in some aspects, process 600 may include transmitting, to the AIoT device, a key confirmation message (block 630). For example, the AIoT controller (e.g., using transmission component 904 and/or communication manager 906) may transmit, to the AIoT device, a key confirmation message, as described herein.

As further shown in FIG. 6, in some aspects, process 600 may include validating, from the AIoT device, a key confirmation acknowledgement using a protection key derived from the root key (block 640). For example, the AIoT controller (e.g., using communication manager 906) may validate, from the AIoT device, a key confirmation acknowledgement using a protection key derived from the root key, as described herein.

Process 600 may include additional aspects, such as any single aspect or any combination of aspects described below and/or in connection with one or more other processes described elsewhere herein.

In a first aspect, the AKA procedure includes an EAP-AKAʹ procedure, and the network function includes an AUSF.

In a second aspect, alone or in combination with the first aspect, the AKA procedure includes a 5G AKA procedure, and the network function includes an AMF.

In a third aspect, alone or in combination with one or more of the first and second aspects, process 600 includes receiving (e.g., using reception component 902 and/or communication manager 906), from the AIoT device, an authentication initiation request, and transmitting (e.g., using transmission component 904 and/or communication manager 906), to the network function, an authentication trigger request.

In a fourth aspect, alone or in combination with one or more of the first through third aspects, process 600 includes transmitting, to the network function, an authentication trigger request.

In a fifth aspect, alone or in combination with one or more of the first through fourth aspects, the authentication trigger request is transmitted in response to detecting that the AIoT controller lacks security keys.

In a sixth aspect, alone or in combination with one or more of the first through fifth aspects, process 600 includes receiving (e.g., using reception component 902 and/or communication manager 906), from an application function, a service request, such that the authentication trigger request is transmitted to the network function in response to the service request.

In a seventh aspect, alone or in combination with one or more of the first through sixth aspects, the authentication trigger request includes a SUPI associated with the AIoT device.

In an eighth aspect, alone or in combination with one or more of the first through seventh aspects, the key confirmation message indicates a selected algorithm.

In a ninth aspect, alone or in combination with one or more of the first through eighth aspects, the key confirmation message is integrity protected based on the protection key that is generated using the root key and the selected algorithm.

In a tenth aspect, alone or in combination with one or more of the first through ninth aspects, the key confirmation acknowledgement is confidentiality and integrity protected based on the protection key.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network function or an apparatus of a network function, in accordance with the present disclosure. Example process 700 is an example where the apparatus or the network function (e.g., network function 235) performs operations associated with network-based authentication in an AIoT architecture.

As shown in FIG. 7, in some aspects, process 700 may include receiving an authentication trigger request associated with an AIoT device (block 710). For example, the network function (e.g., using reception component 1002 and/or communication manager 1006, depicted in FIG. 10) may receive an authentication trigger request associated with an AIoT device, as described herein.

As further shown in FIG. 7, in some aspects, process 700 may include performing an AKA procedure with the AIoT device to generate a master key (block 720). For example, the network function (e.g., using reception component 1002, transmission component 1004, and/or communication manager 1006, depicted in FIG. 10) may perform an AKA procedure with the AIoT device to generate a master key, as described herein.

As further shown in FIG. 7, in some aspects, process 700 may include generating, using the master key with an ID for an AIoT controller, a service ID, or a combination thereof, a root key associated with the AIoT controller (block 730). For example, the network function (e.g., using communication manager 1006) may generate, using the master key with an ID for an AIoT controller, a service ID, or a combination thereof, a root key associated with the AIoT controller, as described herein.

As further shown in FIG. 7, in some aspects, process 700 may include transmitting, to the AIoT controller, the root key (block 740). For example, the network function (e.g., using transmission component 1004 and/or communication manager 1006) may transmit, to the AIoT controller, the root key, as described herein.

Process 700 may include additional aspects, such as any single aspect or any combination of aspects described below and/or in connection with one or more other processes described elsewhere herein.

In a first aspect, the AKA procedure includes an EAP-AKAʹ procedure, and the network function includes an AUSF.

In a second aspect, alone or in combination with the first aspect, the AKA procedure includes a 5G AKA procedure, and the network function includes an AMF.

In a third aspect, alone or in combination with one or more of the first and second aspects, the authentication trigger request includes a SUPI associated with the AIoT device.

In a fourth aspect, alone or in combination with one or more of the first through third aspects, the authentication trigger request includes a SUCI.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be an AIoT device, or an AIoT device may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as an AIoT controller (such as a UE or a network node), using the reception component 802 and the transmission component 804. The communication manager 806 may be included in, or implemented via, a processing system (for example, the processing system 140 described in connection with FIG. 1) of the AIoT device.

In some aspects, the apparatus 800 may be configured to perform one or more operations described herein in connection with FIGS. 3A-3B and/or FIGS. 4A-4B. Additionally, or alternatively, the apparatus 800 may be configured to perform one or more processes described herein, such as process 500 of FIG. 5, or a combination thereof. In some aspects, the apparatus 800 and/or one or more components shown in FIG. 8 may include one or more components of the AIoT device described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the AIoT device described above in connection with FIG. 1, such as a radio, one or more RF chains, one or more transceivers, or one or more modems, each of which may in turn be coupled with one or more antennas of the AIoT device.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the AIoT device described above in connection with FIG. 1, such as a radio, one or more RF chains, one or more transceivers, or one or more modems, each of which may in turn be coupled with one or more antennas of the AIoT device described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

In some aspects, the reception component 802 and/or the transmission component 804 may perform an AKA procedure with a network function to generate a root key. In some aspects, the transmission component 804 may transmit, to the apparatus 808 (e.g., an AIoT controller), an authentication request (e.g., to trigger the AKA procedure). The reception component 802 may receive, from the apparatus 808, a key confirmation message. The communication manager 806 may generate, using the key confirmation message and the root key, a protection key. The transmission component 804 may transmit, to the apparatus 808, a key confirmation acknowledgement using the protection key and in response to the key confirmation message.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be an AIoT controller, or an AIoT controller may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 160 described in connection with FIG. 1. As shown, the apparatus 900 may communicate with another apparatus 908, such as an AIoT device, using the reception component 902 and the transmission component 904. The communication manager 906 may be included in, or implemented via, a processing system (for example, the processing system 145 described in connection with FIG. 1) of the AIoT controller.

In some aspects, the apparatus 900 may be configured to perform one or more operations described herein in connection with FIGS. 3A-3B and/or FIGS. 4A-4B. Additionally, or alternatively, the apparatus 900 may be configured to perform one or more processes described herein, such as process 600 of FIG. 6, or a combination thereof. In some aspects, the apparatus 900 and/or one or more components shown in FIG. 9 may include one or more components of the AIoT controller described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the AIoT controller described above in connection with FIG. 1, such as a radio, one or more RF chains, one or more transceivers, or one or more modems, each of which may in turn be coupled with one or more antennas of the AIoT controller.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the AIoT controller described above in connection with FIG. 1, such as a radio, one or more RF chains, one or more transceivers, or one or more modems, each of which may in turn be coupled with one or more antennas of the AIoT controller described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

In some aspects, the reception component 902 and/or the transmission component 904 may forward messages between the apparatus 908 (e.g., an AIoT device) and a network function to facilitate an AKA procedure. In some aspects, the reception component 902 may receive, from the apparatus 908, an authentication initiation request, and the transmission component 904 may transmit, to the network function, an authentication trigger request (e.g., to trigger the AKA procedure). Alternatively, the reception component 902 may receive, from an application function, a service request, and the transmission component 904 may transmit, to the network function, an authentication trigger request (e.g., to trigger the AKA procedure).

The reception component 902 may receive, from the network function, a root key associated with the apparatus 900. The transmission component 904 may transmit, to the apparatus 908, a key confirmation message. The communication manager 906 may validate a key confirmation acknowledgement (e.g., received by the reception component 902 from the apparatus 908) using a protection key derived from the root key.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network function, or a network function may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 165 described in connection with FIG. 1. As shown, the apparatus 1000 may communicate with another apparatus 1008, such as an AIoT controller (such as a UE or a network node), using the reception component 1002 and the transmission component 1004. The communication manager 1006 may be included in, or implemented via, a processing system (for example, the processing system 150 described in connection with FIG. 1) of the network function.

In some aspects, the apparatus 1000 may be configured to perform one or more operations described herein in connection with FIGS. 3A-3B and/or FIGS. 4A-4B. Additionally, or alternatively, the apparatus 1000 may be configured to perform one or more processes described herein, such as process 700 of FIG. 7, or a combination thereof. In some aspects, the apparatus 1000 and/or one or more components shown in FIG. 10 may include one or more components of the network function described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network function described above in connection with FIG. 1, such as a radio, one or more RF chains, one or more transceivers, or one or more modems, each of which may in turn be coupled with one or more antennas of the network function.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network function described above in connection with FIG. 1, such as a radio, one or more RF chains, one or more transceivers, or one or more modems, each of which may in turn be coupled with one or more antennas of the network function described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

In some aspects, the reception component 1002 may receive an authentication trigger request associated with an AIoT device. The reception component 1002 and/or the transmission component 1004 may perform an AKA procedure with the AIoT device (e.g., via the apparatus 1008) to generate a master key. The communication manager 1006 may generate, using the master key with an ID for the apparatus 1008 (e.g., an AIoT controller), a service ID, or a combination thereof, a root key associated with the apparatus 1008. The transmission component 1004 may transmit, to the apparatus 1008, the root key.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by an ambient Internet of Things (AIoT) device, comprising: performing an authentication and key agreement (AKA) procedure with a network function to generate a root key; receiving, from an AIoT controller, a key confirmation message; generating, using the key confirmation message and the root key, a protection key; and transmitting, to the AIoT controller, a key confirmation acknowledgement using the protection key and in response to the key confirmation message.

Aspect 2: The method of Aspect 1, wherein the AKA procedure comprises an extensible authentication protocol (EAP) AKAʹ procedure, and the network function comprises an authentication server function (AUSF).

Aspect 3: The method of any of Aspects 1-2, wherein the root key is generated based on a master key that is generated as a result of the AKA procedure and using an identifier (ID) for the AIoT controller, a service ID, or combination thereof.

Aspect 4: The method of any of Aspect 1, wherein the AKA procedure comprises a fifth generation (5G) AKA procedure, and the network function comprises an access and mobility management function (AMF).

Aspect 5: The method of any of Aspects 1-4, further comprising: transmitting, to the AIoT controller, an authentication request.

Aspect 6: The method of Aspect 5, wherein the authentication request is transmitted in response to detecting that the AIoT device lacks security keys.

Aspect 7: The method of any of Aspects 1-6, wherein the key confirmation message indicates a selected algorithm.

Aspect 8: The method of Aspect 7, wherein the key confirmation message is integrity protected based on the protection key that is generated using the root key and the selected algorithm.

Aspect 9: The method of any of Aspects 1-8, wherein the key confirmation acknowledgement is confidentiality and integrity protected based on the protection key.

Aspect 10: A method of wireless communication performed by an ambient Internet of Things (AIoT) controller, comprising: forwarding messages between an AIoT device and a network function to facilitate an authentication and key agreement (AKA) procedure; receiving, from the network function, a root key associated with the AIoT controller; transmitting, to the AIoT device, a key confirmation message; and validating, from the AIoT device, a key confirmation acknowledgement using a protection key derived from the root key.

Aspect 11: The method of Aspect 10, wherein the AKA procedure comprises an extensible authentication protocol (EAP) AKAʹ procedure, and the network function comprises an authentication server function (AUSF).

Aspect 12: The method of Aspect 10, wherein the AKA procedure comprises a fifth generation (5G) AKA procedure, and the network function comprises an access and mobility management function (AMF).

Aspect 13: The method of any of Aspects 10-12, further comprising: receiving, from the AIoT device, an authentication initiation request; and transmitting, to the network function, an authentication trigger request.

Aspect 14: The method of any of Aspects 10-13, further comprising: transmitting, to the network function, an authentication trigger request.

Aspect 15: The method of Aspect 14, wherein the authentication trigger request is transmitted in response to detecting that the AIoT controller lacks security keys.

Aspect 16: The method of Aspect 14, further comprising: receiving, from an application function, a service request, wherein the authentication trigger request is transmitted to the network function in response to the service request.

Aspect 17: The method of any of Aspects 14-16, wherein the authentication trigger request includes a subscription permanent identifier (SUPI) associated with the AIoT device.

Aspect 18: The method of any of Aspects 10-17, wherein the key confirmation message indicates a selected algorithm.

Aspect 19: The method of Aspect 18, wherein the key confirmation message is integrity protected based on the protection key that is generated using the root key and the selected algorithm.

Aspect 20: The method of any of Aspects 10-19, wherein the key confirmation acknowledgement is confidentiality and integrity protected based on the protection key.

Aspect 21: A method of wireless communication performed by a network function, comprising: receiving an authentication trigger request associated with an ambient Internet of Things (AIoT) device; performing an authentication and key agreement (AKA) procedure with the AIoT device to generate a master key; generating, using the master key with an identifier (ID) for an AIoT controller, a service ID, or a combination thereof, a root key associated with the AIoT controller; and transmitting, to the AIoT controller, the root key.

Aspect 22: The method of Aspect 21, wherein the AKA procedure comprises an extensible authentication protocol (EAP) AKAʹ procedure, and the network function comprises an authentication server function (AUSF).

Aspect 23: The method of Aspect 21, wherein the AKA procedure comprises a fifth generation (5G) AKA procedure, and the network function comprises an access and mobility management function (AMF).

Aspect 24: The method of any of Aspects 21-23, wherein the authentication trigger request includes a subscription permanent identifier (SUPI) associated with the AIoT device.

Aspect 25: The method of any of Aspects 21-24, wherein the authentication trigger request includes a subscription concealed identifier (SUCI).

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

Aspect 33: A device comprising a processing system that includes one or more processors and one or more code-storing memories coupled with the one or more processors, the processing system configured to cause the device to perform the method of one or more of Aspects 1-25.

Aspect 34: A device comprising a processing system that includes processor circuitry and code-storing memory circuitry, the processing system configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An ambient Internet of Things (AIoT) device, comprising:
a processing system that includes one or more processors and one or more code-storing memories coupled with the one or more processors, the processing system configured to cause the AIoT device to:
perform an authentication and key agreement (AKA) procedure with a network function to generate a root key;
receive, from an AIoT controller, a key confirmation message;
generate, using the key confirmation message and the root key, a protection key; and
transmit, to the AIoT controller, a key confirmation acknowledgement using the protection key and in response to the key confirmation message.

2. The AIoT device of claim 1, wherein the AKA procedure comprises an extensible authentication protocol (EAP) AKAʹ procedure, and the network function comprises an authentication server function (AUSF).

3. The AIoT device of claim 1, wherein the root key is generated based on a master key that is generated as a result of the AKA procedure and using an identifier (ID) for the AIoT controller, a service ID, or combination thereof.

4. The AIoT device of claim 1, wherein the AKA procedure comprises a fifth generation (5G) AKA procedure, and the network function comprises an access and mobility management function (AMF).

5. The AIoT device of claim 1, wherein the processing system is configured to cause the AIoT device to:
transmit, to the AIoT controller, an authentication request.

6. The AIoT device of claim 5, wherein the authentication request is transmitted in response to detecting that the AIoT device lacks security keys.

7. The AIoT device of claim 1, wherein the key confirmation message indicates a selected algorithm.

8. The AIoT device of claim 7, wherein the key confirmation message is integrity protected based on the protection key that is generated using the root key and the selected algorithm.

9. The AIoT device of claim 1, wherein the key confirmation acknowledgement is confidentiality and integrity protected based on the protection key.

10. A method of wireless communication performed by an ambient Internet of Things (AIoT) device, comprising:
performing an authentication and key agreement (AKA) procedure with a network function to generate a root key;
receiving, from an AIoT controller, a key confirmation message;
generating, using the key confirmation message and the root key, a protection key; and
transmitting, to the AIoT controller, a key confirmation acknowledgement using the protection key and in response to the key confirmation message.

11. The method of claim 10, wherein the AKA procedure comprises an extensible authentication protocol (EAP) AKAʹ procedure, and the network function comprises an authentication server function (AUSF).

12. The method of claim 10, wherein the root key is generated based on a master key that is generated as a result of the AKA procedure and using an identifier (ID) for the AIoT controller, a service ID, or combination thereof.

13. The method of claim 10, wherein the AKA procedure comprises a fifth generation (5G) AKA procedure, and the network function comprises an access and mobility management function (AMF).

14. The method of claim 10, further comprising:
transmitting, to the AIoT controller, an authentication request.

15. The method of claim 14, wherein the authentication request is transmitted in response to detecting that the AIoT device lacks security keys.

16. The method of claim 10, wherein the key confirmation message indicates a selected algorithm.

17. The method of claim 16, wherein the key confirmation message is integrity protected based on the protection key that is generated using the root key and the selected algorithm.

18. The method of claim 10, wherein the key confirmation acknowledgement is confidentiality and integrity protected based on the protection key.

19. A non-transitory computer-readable medium storing a set of instructions for wireless communication, the set of instructions comprising:
one or more instructions that, when executed by one or more processors of an ambient Internet of Thins (AIoT) device, cause the AIoT device to:
perform an authentication and key agreement (AKA) procedure with a network function to generate a root key;
receive, from an AIoT controller, a key confirmation message;
generate, using the key confirmation message and the root key, a protection key; and
transmit, to the AIoT controller, a key confirmation acknowledgement using the protection key and in response to the key confirmation message.

20. The non-transitory computer-readable medium of claim 19, wherein the AKA procedure comprises an extensible authentication protocol (EAP) AKAʹ procedure or a fifth generation (5G) AKA procedure.
